(19) United States
(12) Patent Application Publication
(10) Pub. No.: US 2010/0153276 A1
(43) Pub. Date: Jun. 17, 2010

(54) METHOD AND SYSTEM FOR ONLINE PAYMENT AND IDENTITY CONFIRMATION WITH SELF-SETTING AUTHENTICATION FOMULA

(76) Inventor: Kamfu Wong, Hong Kong (CN)

Correspondence Address: PERKINS COIE LLP, POST OFFICE BOX 1208, SEATTLE, WA, 98111-1208, US

(21) Appl. No.: 12/374,086

(22) PCT Filed: Jul. 20, 2006
(86) PCT No.: PCT/CN06/01787

§ 371 Date: Jan. 27, 2010

(51) Int. Cl. H04L 9/32; G06Q 20/00; H04L 9/16

(52) U.S. Cl. 705/72; 705/44

(57) ABSTRACT

A system and a method are used for certification when paying online or confirming the user's identity using the communication network. The system mainly includes a certification system (1), a bank website (2), a mobile telephone network (3), a user terminal (4) and a user mobile telephone (5) and so on. The method includes: the step for certification between the certification system (1) and the user mobile telephone (5) using the mobile telephone network (3), the step for calculating the certification code (8) using a certification formula (7) defined by the user (6), the step for certification by sending the certification formula (7) defined by the user (6) to the certification system (1) and storing it therein, then calculating the certification code (8) in the certification system (1) or by sending the certification formula (7) defined by the user (6) to the bank website (2) and storing it therein, then calculating the certification code (8) in the bank website (2). The present invention may efficiently prevent any hacker from hacking the certification code (8), and thus the use of the method and system provides high security for online payment.

### TECHNICAL FIELD

The present invention relates to a method and system for online payment, and particularly to a method and system for online payment with random certification.

### BACKGROUND OF THE INVENTION

The popularity of online payment such as e-bank is increasing. Due to the popularity of online shopping, online business purchasing and online individual shopping and the like are made via the e-bank, either paying by credit card through a network or paying by using a communication network system, and even the depositing and withdrawing of money via an automatic teller machine or ATM of a bank are also made by using a communication network system. However, the security of online payment is of the greatest importance for payment via a network. Many of previous patents or patent applications have related to this issue, including previous patent applications of numbers 00109820.9 and 01119849.4 to the inventor, both of which propose to use random dynamic code for online certification so as to assure secure online payment. Since there are hackers in the network industry who often take advantage of loopholes in network programs to hack the information of paying customers, such as bank customers, customers owning various fiscards, etc. during online transactions, including hacking the random dynamic code. As a result, secure online payment is somewhat threatened and the dynamic code may be stolen, which may incur losses to various persons such as bank customers when they pay online.

Therefore, a more advanced certification method for online payment and the corresponding system thereof are desirable, and a method and system in which any hacker will not succeed even if he has stolen the dynamic code is also in an urgent need.

### SUMMARY OF THE INVENTION

The object of the present invention is to provide a novel certification method for online payment and the corresponding system thereof, in which a dynamic code can not work directly and thus can not be used directly even if it is stolen, thereby assuring the security of online payment via the communication network. The system of the present invention is also applicable to all circumstances of online payment, including banking, credit card certification, ATM withdrawing certification and the like. In the specification, the bank website (2) refers to various online payment facilities.

The object of the present invention is achieved by adopting such a method for certification when paying online using a communication network, said method comprising the steps of:

certificating between a certification system (1) and a user mobile telephone (5) via a mobile telephone network (3),

calculating a certification code (8) using a certification formula (7) defined by the user (6),

certificating by sending the certification formula (7) defined by the user (6) to the certification system (1) and storing it therein, then the certification system (1) calculating the certification code (8), or by sending the certification formula (7) defined by the user (6) to the bank website (2) and storing it therein, then the bank website (2) calculating the certification code (8);

and the object is also achieved by a communication network certification system mainly comprising a certification system (1), a bank website (2), a mobile telephone network (3), a user terminal (4) and a user mobile telephone (5), a certification formula (7) defined by the user (6) and a certification code (8) and the like.

The present invention is characterized in that an alternative approach certification method is used, in which the mobile telephone network is also used as a second approach for the transmission of certification information, in addition to using the original network for the transmission of certification information. The certification center places a call to the user telephone using a dynamic telephone number, the last part of the displayed number seen by the user on the mobile telephone being a random dynamic code. The certification code is calculated with the certification formula pre-defined by the user using operations such as addition, subtraction, multiplication and division, and then the user uses his/her own mobile telephone to dial the telephone number composed of the main telephone number of the certification system and the certification code to the certification system. The certification system recognizes, from the incoming call number, that it is the call placed by the user, the last part of the dialed number being the certification code of the user. Even if the dynamic code is intercepted by a hacker, since the hacker can not calculate the certification code without the user's own formula, and the certification code is required to be transmitted from the mobile telephone of the user, the hacker can not be successfully certificated. The present invention is applicable to all online payment certifications and various applications that require certifications, including e-bank certification, credit card certification, ATM withdrawing certification, credit card companies, stock broker companies, file storage certification, financial institutions, website and personal information certifications.

The important features and advantages of the present invention are the method for certification, which may improve the deficiency of current certification that uses only the code, and may make full use of the characteristics that the mobile telephone network and the mobile telephone may not be forged easily, thereby using a simple and low cost method to implement the alternative approach certification. Take the GSM mobile telephone network for example, if someone duplicates the SIM card of a user, as soon as the coexistence of the mobile telephone with the duplicated SIM card and the mobile telephone of the user is detected, the mobile telephone company will disable the mobile telephone number and the SIM card of the user. Later, the user should apply to the mobile telephone company for a new SIM card so that he/she can continue to use this mobile telephone number. This characteristic makes the mobile telephone network more secure and reliable compared with the Internet.

Furthermore, the main advantages and features of the present invention include:

1. The certification formula is defined by the user and is known only by the user, and the user calculates the certification code using the certification formula upon receipt of the random code. So far, however, no additional formula is used for confirmation, while commonly the received code or the code displayed on a code generator is directly inputted. This is the innovation of the present invention.

2. The code is transmitted by means of caller ID display.

3. Two different approaches are used for certification, one being the currently-used Internet, the other being the mobile telephone network.

### DESCRIPTION OF THE DRAWINGS

FIG. 1 is an illustration of the method and system according to the present invention.

### DESCRIPTION OF PREFERRED EMBODIMENTS

The method and system according to the present invention will be further described in detail below in connection with the accompanying drawing.

The described drawing and its illustration are all illustrative, and the spirit of the present invention is not limited by the specific illustration of the embodiments.

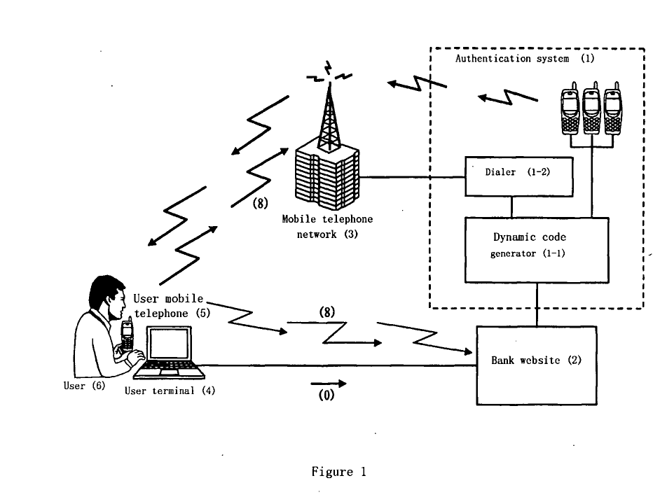

Referring now to FIG. 1, which shows the system according to the present invention. The communication network certification system according to the present invention mainly comprising:

a certification system (1), which is a communication device having a computer, mainly including a random dynamic code generator (1-1) and a dialer (1-2), wherein the random dynamic code generator (1-1) is a computer server, having a random code generation program installed therein for generating a random numeric string code of specified length, in accordance with predetermined procedures; a dialer (1-2), which is a telephone exchange device connected to the mobile telephone network directly or through the fixed telephone network, wherein the telephone number of the user mobile telephone may be dialed in accordance with predetermined procedures using the line of the telephone number provided by the mobile telephone network or fixed telephone network operator; or the random dynamic code may also be sent to the user by means of SMS or MMS in accordance with predetermined procedures;

a bank website (2), which is an online transaction website for various of financial institutions or a website that needs to certificate the user's identity;

a mobile telephone network (3), which is a common mobile telephone network, such as GSM network, CDMA network, etc.;

a user terminal (4), generally being a computer or any of various electronic devices that can be connected to the network and be capable of online payment,

a user mobile telephone (5),

a certification formula (7), which is defined by the user (6) and by which the certification code (8) is calculated, wherein certification is performed by the user by sending the certification formula (7) defined by the user to the certification system (1) and storing it therein, then the certification system (1) calculating the certification code (8), or by the user by sending the certification formula (7) defined by the user to the bank website (2) and storing it therein, then the bank website (2) calculating the certification code (8).

With the utilization of the above described system of the present invention, the object of the present invention may be achieved in several different steps.

The first set of methods according to the present invention is composed of the set A of steps A1 to A8, wherein:
A1. the certification is performed by the user (6) by defining the certification formula (7) in the certification system (1) in advance and storing it therein, then the certification system (1) calculating the certification code (8);
A2. The user (6) logs on the bank website (2) using the user terminal (4), and enters the log-in account number and password (0) therein;
A3. After checking that the log-in account number and password of the user (6) are correct, the bank website (2) finds the number of the user mobile telephone (5) from the log-in account number of the user (6), and sends the number of the user mobile telephone (5) to the certification system (1);
A4. The certification system (1) generates a random dynamic code having a length of N digits through the dynamic code generator (1-1), and then dials, through the dialer (1-2), the number of the user mobile telephone (5) using the telephone line of the telephone number composed of the main telephone number of the certification system (1) and the random dynamic code, and hooks on as soon as the call is put through;
A5. When the user (6) sees the caller number of the certification system (1) by means of the caller ID display on the mobile telephone (5), he/she knows that the last N digits of the number of the incoming call are the random dynamic code, and then calculates the certification code (8) using the certification formula (7) pre-defined by the user;
A6. The user (6) replaces the original last N digits of the incoming call from the certification system (1) with the N digits of the certification code (8) in order to form a certification telephone number including the certification code (8), and then dials the certification telephone number to the certification system (1) through the user mobile telephone (5), and hooks on as soon as the call is put through;
A7. Upon receipt of the incoming call from the user (6), the certification system (1) finds the number dialed to the user mobile telephone (5) in step A4 and the random code from the records of the certification system (1) based on the number of the incoming call from the user mobile telephone (5), calculates the certification code (8) and the certification telephone number based on the random code using the certification formula (7) defined by the user in step A1, the certification is successful as long as the certification telephone number calculated is the same as the certification telephone number dialed by the user mobile telephone;
A8. Upon successful certification, the certification system (1) informs the bank website (2) that the number of the mobile telephone (5) just sent by the bank website (2) in step A3 is certificated successfully, and the bank website (2) may permit the user (6) to log on formally.

For the N digits in the above described steps A4, A5 and A6, N is a positive integer, preferably 6 or 7 or 8.

The certification system (1) of the present invention has a particularly unique nature that is as unique DNA gene in a human body, and hence the certification system (1) in the system of the present invention may also be called DNA certification system.

To implement the present invention in terms of telephone numbers of communications, DNA certification system is required first to apply to the mobile telephone company or fixed telephone network company for a plurality of telephone lines and a plurality of telephone numbers, for example, for 100 telephone lines and 1,000,000 telephone numbers, wherein the last 6 digits of a telephone number, or other code length, i.e., the above mentioned N digits, may be used as the code (e.g., 95599-XXXXXX), and the telephone number may be extended, i.e., more digits may be added to the end of the commonly-used telephone numbers, for the purpose of increasing usable numbers. Take Hong Kong telephone numbers for example, a telephone number in Hong Kong has 8 digits, upon addition of 3 digits to the number, the number of usable telephone numbers are significantly increased by 1,000 times. For example, when one applies to the telephone company for a set of telephone numbers beginning with fixed 5 digits, occupying 1,000 of 8-digit telephone numbers. If the telephone number is changed to 11-digit telephone number by the addition of 5 digits, the number of all the usable telephone numbers will be up to 1,000,000. For example, the telephone number beginning with fixed digits of 31000 is 31000XXXXXX, the usable numbers are from 31000000000 to 31000999999, totaling 1,000,000 telephone numbers, wherein the first 5 digits are fixed and used as the so-called main telephone number of the DNA certification system (1). The user will know that it is the number from the DNA certification system (1) as soon as he/she sees the incoming call number beginning with these 5 digits.

At the same time, the user (6) has to register his/her own mobile telephone number on the website and set the log-on account number and password for the bank website (2), and define a set of certification formulas (7); the certification formula (7) is defined by the user, which may be operations such as addition, subtraction, multiplication, division and shift, and the calculating method is defined by the user.

The above description is applicable to each set of methods according to the present invention, including those illustrated in set B of steps and set C of steps described below.

In the above step A5, the certification formula (7) defined by the user (6) is for example: (the random dynamic code+1968)/12−8, wherein the decimal point is ignored, that is, the first 6 digits form the certification code (8).

For example, the user (6) sees that the number of the incoming call from the certification system (1) on the mobile telephone (5) is 31000546382, he/she knows that the last 6 digits, i.e., 546382, are the random code.

The certification formula is calculated as: (546382+1968)/12−8=45687.833333;

The decimal point in the result 45687.833333 is ignored, that is, the first 6 digits of 45687.833333, i.e., 456878, are the certification code (8).

In addition, step A9 may be added to the above steps, that is:

A9. When the user (6) makes a transaction of a large amount of money, the bank website (2) may again ask the user to certificate, in order to ensure the security of the user account.

The amount of the transaction of a large amount of money may be determined respectively by each of banks, financial institutions and user (6) according to particular situations.

The specific steps of the second embodiment of the method of the present invention are composed of the following steps B1 to B8, wherein:
B1. the certification is performed by the user (6) by defining the certification formula (7) in the bank in advance and storing it in the bank website (2), then the bank website (2) calculating the certification code (8);
B2. The user (6) logs on the bank website (2) using the user terminal (4), and enters the log-in account number and password (0) therein;
B3. After checking that the log-in account number and password of the user (6) are correct, the bank website (2) finds the number of the user mobile telephone (5) from the log-in account number of the user (6), and sends the number of the user mobile telephone (5) to the certification system (1);
B4. the certification system (1) generates a random dynamic code having a length of N digits through the dynamic code generator (1-1), and sends the random dynamic code to the user by one of:
   B41. dialing, through the dialer (1-2), the number of the mobile telephone (5) of the user (6) using the telephone line of the telephone number composed of the main telephone number of the certification system (1) and the random dynamic code, and hooks on as soon as the call is put through; or
   B42. sending, by the certification system (1), the random dynamic code to the user mobile telephone (5) via text message; or
   B43. sending, by the certification system (1), the random dynamic code to the user mobile telephone (5) via MMS;
   sending, by the certification system (1), the random dynamic code to the bank website (2) at the same time;
B5. When the user (6) sees the caller number of the certification system (1) by means of the caller ID display on the mobile telephone (5), he/she knows that the last N digits of the number of the incoming call are the random dynamic code, or sees the random dynamic code from the content of the text message or MMS, and then calculates the certification code (8) using the certification formula (7) pre-defined by the user (6);
B6. Entering, by the user (6), the N digits of the certification code (8) to the bank website (2);
B7. The bank website calculates the certification code (8) using the certification formula defined by the user (6) in step B1 from the random dynamic code sent by the certification system (1) in step B4, the certification is successful as long as the certification code (8) calculated is the same as the certification code entered by the user (6) in step B6;
B8. Upon successful certification, the bank website (2) may permit the user (6) to log on formally.

Similarly, for example, in the above step B5, the certification formula (7) defined by the user (6) is for example: (the random dynamic code+1968)/12−8, wherein the decimal point is ignored, that is, the first 6 digits form the certification code (8).

For example, the user (6) sees that the number of the incoming call from the certification system (1) is 31000546382, he/she knows that the last 6 digits, i.e., 546382, are the random code,

then the certification formula is calculated as: (546382+1968)/12−8=45687.833333;

The decimal point in the result 45687.833333 is ignored, that is, the first 6 digits of 45687.833333, i.e., 456878, are the certification code (8).

Similarly, step B9 may also be added, that is:

B9. When the user (6) makes a transaction of a large amount of money, the bank website (2) may again ask the user to certificate, in order to ensure the security of the user account.

A further improvement on the set B of steps in the present embodiment is embodied in step B5, in which, as soon as the user (6) receives the caller call from the certification system (1) with the random dynamic code number, he/she uses his/her mobile telephone (5) to dial the random dynamic code telephone number, and hooks on as soon as the call is put through; on the other hand, upon receipt of the incoming call, the certification system (1) knows that it is a call from the user (6) based on the number of the incoming call and that the user (6) has confirmed, and transmits the confirmation information to the bank website (2) immediately. In this way, the security of certification may further be enhanced.

The specific steps in the third set of steps of the present invention are composed of the following steps C1 to C8, wherein:
C1. the certification is performed by the user (6) by defining the certification formula (7) in the certification system (1) in advance and storing it therein, then the certification system (1) calculating the certification code (8);
C2. The user (6) logs on the bank website (2) using the user terminal (4), and enters the log-in account number and password (0) therein;
C3. After checking that the log-in account number and password of the user (6) are correct, the bank website (2) finds the number of the user mobile telephone (5) from the log-in account number of the user (6), and sends the number of the user mobile telephone (5) to the certification system (1);
C4. The certification system (1) generates a random dynamic code having a length of N digits through the dynamic code generator (1-1), and sends the random dynamic code to the user mobile telephone (5) by means of text message or MMS;
C5. The user (6) knows that it is a text message or MMS sent by the certification system (1) based on the caller number in the text message or MMS, and sees the random dynamic code from the content of the text message or MMS, and then calculates the certification code (8) using the certification formula (7) predefined by the user (6);
C6. The user (6) uses his/her own mobile telephone (5) to transmit the certification code (8) back to the certification system (1) by means of text message or MMS;
C7. Upon receipt of the certification code (8) sent back by the user (6) using his/her mobile telephone (5), the certification system (1) finds the random dynamic code sent to the user (6) in step C4 from the records of the certification system (1) based on the number of the incoming call from the user mobile telephone (5), calculates the certification code (8) based on the random dynamic code using the certification formula (7) defined by the user (6) in step C1, the certification is successful as long as the certification code (8) calculated is the same as the certification code sent back by the user mobile telephone;
C8. Upon successful certification, the certification system (1) informs the bank website (2) that the number of the mobile telephone (5) just sent by the bank website (2) in step C3 is certificated successfully, and the bank website (2) may permit the user (6) to log on formally.

As in the previously described set A of steps and set B of steps, the same example is used in step C5, in which the calculation of the certification code based on the certification formula (7) is illustrated.

Similarly, the certification formula (7) defined by the user (6) is for example: (the random dynamic code+1968)/12−8, wherein the decimal point is ignored, that is, the first 6 digits form the certification code (8).

For example, the user (6) sees that the caller number is 31000546382, he/she knows that the last 6 digits, i.e., 546382, are the random code,

then the certification formula is calculated as: (546382+1968)/12−8=45687.833333;

The decimal point in the result 45687.833333 is ignored, that is, the first 6 digits of 45687.833333, i.e., 456878, are the certification code (8).

The certification formula (7) is defined by the user (6), and more examples of the certification formula (7) defined by the user are illustrated as follows:

### Example 1

a six-digit code is used, and the random code is 945218:

The certification formula (7) is: the random code×7−111100,

945218×7−111100=6505426,

The first six digits, i.e., 650542, are the certification code (8);

### Example 2

an eight-digit code is used, and the random code is 54125236,

The certification formula (7) is: (the resulting number obtained by exchanging the first two digits with the last two digits for the random code)×3,

Exchanging the first two digits with the last two digits for 54125236=36125254,

36125254×3=108375762,

The first eight digits, i.e., 10837576, are the certification code (8);

### Example 3

a seven-digit code is used, and the random code is 6589462,

The certification formula (7) is: (the resulting number obtained by changing the 4^{th} to 6^{th} digits to 128)×9+1668,

Changing the 4^{th} to 6^{th} digits for 6589462 to 128=6581282,

6581282×9+1668=59233206,

The first seven digits, i.e., 5923320, are the certification code (8);

### Example 4

a ten-digit code is used, and the random code is 9452123176,

The certification formula (7) is: (the 7^{th} digit for the random code+1 and the 8^{th} digit+1),

The 7^{th} digit+1 and the 8^{th} digit+1 for 9452123176=9452124276,

The first ten digits, i.e., 9452124276, are the certification code (8);

The length (digits) of the random code, i.e., the random dynamic code may be the same as the certification code (8), for example, “N” as used in this specification is only to make it convenient for user to remember. Instead, the two can be of different length, for example, it is also possible that the certification code (8) is fixed to 6 digits and so on, which falls within the protected scope of the present invention.

Since telephone numbers used in telephone networks in various countries are different in length, a dynamic code with an appropriate length may be selected accordingly; the most ideal length is 6 to 8 digits. The mobile telephone network used in the present invention is not connected to the Internet directly, so even if a hacker hacks the log-on password of the user (6) using any Trojan and Spyware programs, as he does not have the mobile telephone (5) of the user (6), he can not receive the random dynamic code from the DNA certification system; besides, the hacker does not have the certification formula (7) defined by the user (6) either, so he can not be certificated, thereby assuring the security of online payment for the user (6).

In view of the foregoing, a ninth step may be added to the end of the various above-mentioned sets of steps, that is:

When the user (6) makes a transaction of a large amount of money, the bank website (2) may again ask the user to certificate, in order to ensure the security of the user account.

And the algorithm of the certification code (8) is that, when the non-integer result is obtained by calculating the random dynamic code using the certification formula (7), the decimal point of the result is ignored, that is, the first N digits are the certification code (8).

The abbreviation MMS used herein refers to Multimedia Messaging Service.

Also, the above described certification method is characterized in that, the certification method performs certification via two different approaches, one being the currently-used Internet, the other being the mobile telephone network (3).

And the above described certification method is characterized in that, both of the random dynamic code and the certification code (8) are transmitted using caller ID display.

And the above described certification method is applicable to all online payment certifications, including e-bank certification, credit card certification, ATM withdrawing certification, and also including various applications that require certification, such as user's identity certification, personal loan database certification, website and personal information certification, financial institution certification, file storage certification, stock broker company certification, and the like.

The implementation of the certification method according to the present invention may bring excellent effects for parties like the bank and the user.

1. A method for certification when paying online and/or confirming a user's identity using a communication network, the method comprising the following steps:
certificating between a certification system (1) and a user mobile telephone (5) through a mobile telephone network (3);
calculating a certification code (8) using a certification formula (7) defined by the user (6);
certificating by the user (6) by sending the certification formula (7) defined by the user (6) to the certification system (1) or a bank website (2) wherein the certification formula (7) being stored and the certification code (8) being calculated.

2. The method for certification according to claim 1, comprising the following steps of A1, A2, A3, A4, A5, A6, A7 and A8, wherein:
A1. the user (6) defining and storing the certification formula (7) in the certification system (1) in advance, then the certification system (1) calculating the certification code (8) for certification;
A2. the user (6) logging on to the bank website (2) using a user terminal (4) by entering a log-in account number and password (0) therein;
A3. after checking that the log-in account number and password (0) of the user (6) are correct, the bank website (2) finding the number of the user mobile telephone (5) according to the log-in account number of the user (6), and sending the number of the user mobile telephone (5) to the certification system (1);
A4. the certification system (1) generating a random dynamic code having a length of N digits through a dynamic code generator (1-1), and then dialing the number of the user mobile telephone (5) through a dialer (1-2) using a caller number composed of a main telephone number of the certification system (1) and the random dynamic code, and hanging up as soon as the call being connected;
A5. the user (6) receiving the caller number of the certification system (1) by means of a caller ID display on the mobile telephone (5), the last N digits of the number of the incoming call being the random dynamic code, and then calculating the certification code (8) using the certification formula (7) pre-defined by the user;
A6. the user (6) replacing the original random dynamic code with the N digits of the certification code (8) in order to form a certification telephone number including the certification code (8), and then dialing the certification telephone number to the certification system (1) through the user mobile telephone (5), and hanging up as soon as the call being connected;
A7. upon receipt of the incoming call from the user (6), the certification system (1) finding the number dialed to the user mobile telephone (5) in step A4 and the random dynamic code from the records of the certification system (1) based on the number of the incoming call from the user mobile telephone (5), calculating the certification code (8) and the certification telephone number based on the random dynamic code using the certification formula (7) defined by the user in step A1, the certification is successful when the certification telephone number calculated is the same as the certification telephone number dialed by the user mobile telephone;
A8. upon successful certification, the certification system (1) informing the bank website (2) that the number of the mobile telephone (5) just sent by the bank website (2) in step A3 is certificated successfully, and the bank website (2) may permit the user (6) to log on formally.

3. The method for certification according to claim 1, comprising the following steps of B1, B2, B3, B4, B5, B6, B7, and B8, wherein:
B1. the user (6) defining the certification formula (7) in a bank in advance and storing the certification formula (7) in the bank website (2), then the bank website (2) calculating the certification code (8) for certification;
B2. the user (6) logging on to the bank website (2) using a user terminal (4) by entering a log-in account number and password (0) therein;
B3. after checking that the log-in account number and password of the user (6) are correct, the bank website (2) finding a number of the user mobile telephone (5) from the log-in account number of the user (6), and sending the number of the user mobile telephone (5) to the certification system (1);
B4. the certification system (1) generating a random dynamic code having a length of N digits through a dynamic code generator (1-1), and sending the random dynamic code to the user by a method selected from the group consisting of B41, B42, and B43:
B41. dialing the number of the mobile telephone (5) of the user (6) through a dialer (1-2) using a telephone line of a telephone number composed of a main telephone number of the certification system (1) and the random dynamic code, and hanging up as soon as the call being connected;
B42. the certification system (1) sending the random dynamic code to the user mobile telephone (5) via text message;
B43. the certification system (1) sending the random dynamic code to the user mobile telephone (5) via MMS and to the bank website (2) at the same time;
B5. when the user (6) receiving the random dynamic code by receiving the caller number of the certification system (1) by means of a caller ID display on the mobile telephone (5) wherein the last N digits of the number of the incoming call being the random dynamic code, or receiving the random dynamic code from the content of the text message or MMS, then calculating the certification code (8) using the certification formula (7) pre-defined by the user (6);
B6. the user (6) sending the N digits of the certification code (8) to the bank website (2);
B7. the bank website calculating the certification code (8) using the certification formula defined by the user (6) in step B1 from the random dynamic code sent by the certification system (1) in step B4, the certification being successful when the certification code (8) calculated being the same as the certification code entered by the user (6) in step B6;
B8. upon successful certification, the bank website (2) may permit the user (6) to log on formally.

4. The method for certification according to claim 1, comprising the following set C of steps, wherein:
C1. the user (6) defining and storing the certification formula (7) in the certification system (1) in advance, then the certification system (1) calculating the certification code (8) for certification;
C2. the user (6) logging on to the bank website (2) using a user terminal (4) by entering a log-in account number and password (0) therein
C3. after checking that the log-in account number and password of the user (6) are correct, the bank website (2) finding a number of the user mobile telephone (5) from the log-in account number of the user (6), and sending the number of the user mobile telephone (5) to the certification system (1);
C4. the certification system (1) generating a random dynamic code having a length of N digits through a dynamic code generator (1-1), and sends the random dynamic code to the user mobile telephone (5) by means of text message or MMS;
C5. the user (6) knowing that the text message or MMS is sent by the certification system (1) based on the caller number in the text message or MMS, receiving the random dynamic code from the content of the text message or MMS, and then calculating the certification code (8) using the certification formula (7) pre-defined by the user (6);
C6. the user (6) using his/her own mobile telephone (5) to transmit the certification code (8) back to the certification system (1) by means of text message or MMS;
C7. upon receipt of the certification code (8) sent back by the user (6) using his/her mobile telephone (5), the certification system (1) finding the random dynamic code sent to the user (6) in step C4 from the records of the certification system (1) based on the number of the incoming call from the user mobile telephone (5), calculating the certification code (8) based on the random dynamic code using the certification formula (7) defined by the user (6) in step C1, the certification being successful when the certification code (8) calculated is the same as the certification code sent back by the user mobile telephone;
C8. upon successful certification, the certification system (1) informing the bank website (2) that the number of the mobile telephone (5) just sent by the bank website (2) in step C3 is certificated successfully, and the bank website (2) may permit the user (6) to log on formally.

5. The method for certification according to claim 1, when the user (6) makes a transaction of a large amount of money, the bank website (2) will again ask the user to certificate, in order to ensure the security of the user account.

6. The method for certification according to claim 1, when the non-integer result is obtained by calculating the random dynamic code using the certification formula (7), the decimal point of the result will be ignored, and the first N digits will be the certification code (8).

7. The method for certification according to claim 1, wherein the certification method performs certification using two different approaches, one being the currently-used Internet, the other being a mobile telephone network (3).

8. The method for certification according to claim 1, wherein both the random dynamic code and the certification code (8) are transmitted using caller ID display.

9. The method for certification according to claim 1, the method being applied to all online payment certifications and applications that require certification, selected from the group consisting of e-bank certification, credit card certification, ATM withdrawing certification, credit card companies, stock broker companies, file storage certification, financial institutions, and website and personal information certification.

10. A communication network certification system for online payment and/or identity confirmation using a communication network comprising:
a certification system (1), which is a communication device having a computer, mainly including a random dynamic code generator (1-1) and a dialer (1-2), wherein the random dynamic code generator (1-1) is a computer server, having a random code generation program installed therein for generating a random numeric string code of specified length, in accordance with predetermined procedures; the dialer (1-2) is a telephone exchange device connected to a mobile telephone network directly or through a fixed telephone network, wherein a number of a user mobile telephone may be dialed in accordance with predetermined procedures using the line of the telephone number provided by the mobile telephone network or fixed telephone network operator, or the random dynamic code may be sent to the user by means of SMS or MMS in accordance with the predetermined procedures;
a bank website (2), which is an online transaction website for financial institutions or a website that requires certification of the user's identity;
a mobile telephone network (3), which is a common mobile telephone network;
a user terminal (4) selected from the group consisting of a computer and an electronic device that can be connected to the network and be capable of online payment; a user mobile telephone (5); and
a certification formula (7), defined by the user (6) wherein the certification code (8) is calculated by the user sending the certification formula (7) to the certification system (1) or to the bank website (2), storing it therein, and the certification system (1) or the bank website (2) calculating the certification code (8).
